(19) United States
(12) Patent Application Publication
(10) Pub. No.: US 2010/0299094 A1
(43) Pub. Date: Nov. 25, 2010

(54) THERMAL DEFORMATION ERROR COMPENSATION METHOD FOR COORDINATE MEASURING MACHINE

(75) Inventor: Yung-Yuan Hsu, Gongguan Township (TW)

Correspondence Address: Wang Law Firm, Inc., 4989 Peachtree Parkway,, Suite 200, Norcross, GA, 30092, US

(73) Assignee: CARMAR TECHNOLOGY CO., LTD., Taichung City (TW)

(21) Appl. No.: 12/471,377

(22) Filed: May 23, 2009

(51) Int. Cl. G06F 19/00

(52) U.S. Cl. 702/95

(57) ABSTRACT

A thermal deformation error compensation method for a coordinate measuring machine creates thermal deformation and geometric error data at different ambient temperatures including temperatures and machine kinematic parameters to obtain a thermal deformation and geometric error model, and inputs the model into central control unit of the coordinate measuring machine, and converts a 3D error compensation to obtain a thermal deformation and geometric error compensation model, and uses the thermal deformation and geometric error compensation model for performing compensations, so as to complete a thermal deformation and geometric error compensation of the coordinate measuring machine.

### FIELD OF THE INVENTION

The present invention relates to a thermal deformation error compensation method for a coordinate measuring machine, in particular to a method of compensating an error produced by a thermal deformation of a coordinate measuring machine in environments of different temperatures.

### BACKGROUND OF THE INVENTION

As the definition of a geometric error model of a coordinate measuring machine does not take a change of temperature into consideration, a volume (3D) error is positioned at a tool end at any position of the machine motion space. The coordinate measuring machine uses a plurality of independent geometric error terms to represent a volume error of a tool end of the machine caused by a geometric error, and derive a geometric error model according to a mechanical chain of the machine. The aforementioned error terms are substituted into the geometric error model to estimate the volume error at the tool end when the machine is moved to any position in a space.

In the geometric error model of the coordinate measuring machine, there are three major factors affecting a motion space error without considering temperature. Firstly, a non-linear relation exists between thermal expansion coefficient and temperature of various different components and materials of the coordinate measuring machine. Secondly, the thermal deformation model is complicated since the stresses produced by the change of temperature will affect one another after the components of the coordinate measuring machine are assembled. Thirdly, a non-uniform temperature field is produced by a change of space for disposing the coordinate measuring machine or an internal heat source, and the non-uniform temperature field will make the creation of a mathematical model for the thermal deformation more complicated and difficult.

In addition, the coordinate measuring machines tend to be used extensively in manufacture, but a general manufacture operating environment control (such as temperature and humidity, etc) is not as good as the control in a precision-measurement laboratory. More particularly for the temperature control, temperature is one of the major factors affecting the precision of a machine. In addition, if a high-precision coordinate measuring machine is operated, and even the temperature of the operating environment is controlled more strictly, a slight change of temperature may occur. In order to improve the precision of a measurement, a thermal deformation error compensation for a thermal deformation caused by a slight change of temperature must be performed.

Quasi-static errors (geometric errors and thermal deformations) of a coordinate measuring machine can be improved by mechanical and hardware designs (such as selecting and using materials with a low thermal expansion coefficient, improving cooling systems, and machine assembly tolerance) to enhance the precision of the machine. However, the improvements made to the mechanical design, the environment and the equipment are insufficient to eliminate the geometric errors and thermal deformations completely. An error compensation is required for further improving the precision of the coordinate measuring machine, and thus the Quasi-static error can improve and eliminate error sources at the stage of designing the machine or predict and compensate an error through software. These two methods have been used as the major measures for eliminating geometric errors and thermal deformation errors in the past decade.

Therefore, it is a key point of the present invention to overcome the difficulty of creating a mathematical model for the thermal deformation and the volume error of a coordinate measuring machine.

### SUMMARY OF THE INVENTION

Therefore, it is a primary objective of the present invention to overcome the aforementioned shortcomings of the prior art by providing thermal deformation error compensation method for a coordinate measuring machine, such that when the coordinate measuring machine is operated at different ambient temperatures, an error compensation of a thermal deformation can be performed.

The compensation of the spatial volume error of a conventional method is a mechanism established at a specific temperature (such as 20° C.). If temperature is taken into consideration, then geometric error terms are measured at different temperatures, and a model for geometric errors and volume errors at a tool end of the machine at different temperatures can be established, and this model is called a thermal deformation error model. To obtain error data defined for corresponding geometric error terms in the model, several temperatures of a high precision measuring apparatus (such as a laser interferometer) are controlled in a laboratory and used for actually measuring a geometric error occurred when a moving platform of the coordinate measuring machine is positioned at different positions, so as to obtain the corresponding data of the geometric error at different temperatures, and bring the data into the thermal deformation error model to correctly perform a thermal deformation error compensation for the machine. The aforementioned method takes a geometric error model of the temperature and the measured data of the 21 geometric error terms measured at different temperatures as the bases, and installs a temperature sensor in the machine to constitute a thermal deformation error compensation method for the coordinate measuring machine.

To achieve the foregoing objective, the present invention provides a thermal deformation error compensation method comprising the following steps:

Create the thermal deformation and geometric error model: Use the Homogeneous Transformation Matrix (HTM), follow a mechanical chain of a machine, and consider a machine moving table position and a temperature function in a geometric error term to create a thermal deformation and geometric error model of the three-axis machine tool with 21 geometric error terms.

Create actual thermal deformation and geometric error data: including the measured data required for creating the thermal deformation and geometric error model. The measuring method and procedure include the steps of controlling an environment to a specific temperature in a temperature-controlled laboratory, using a controller of the coordinate measuring machine to drive a linear motion axis to situate at a specific position, using a high-precision measuring apparatus (such as a laser interferometer) to perform an actual positioning measurement of a geometric error when a moving machine table is situated at a different position, and then going through a format processing to convert into the same coordinate system and reading format of the thermal deformation and geometric error model. The temperature of the temperature-controlled laboratory is set to another specific temperature, and the aforementioned measurement is repeated to obtain data of errors of the thermal deformation and geometric error terms of the coordinate measuring machine at different specific temperatures and the data are inputted into a control unit of the coordinate measuring machine.

Compensating errors: Obtain mechanical parameters of the coordinate measuring machine, and these parameters are geometric sizes of the three axes X, Y, Z of the coordinate measuring machine mechanical design architecture. Measure an ambient temperature of the coordinate measuring machine by a temperature sensor. Obtain a position of each moving machine table of the coordinate measuring machine from a position sensor (such as an optical encoder scale), and use the position and temperature interpolation method to obtain data corresponding to the thermal deformation and geometric error measured at the ambient temperature and the position. Estimate a 3D error by the thermal deformation and geometric error model to obtain a value for error compensation, when the tool end is situated at any position of the machine motion space. If a measuring probe is situated at any position of the machine motion space, the thermal deformation and geometric error compensation model will be used for the error compensation to complete the thermal deformation and geometric error compensation.

### BRIEF DESCRIPTION OF THE DRAWINGS

FIG. 1 is a schematic view of a mechanical chain and coordinates of a coordinate measuring machine in accordance with the present invention;

FIG. 2 is a schematic view of defining coordinate systems of a coordinate measuring machine in accordance with the present invention;

FIG. 3 is a schematic view of six error terms of a linear axis in accordance with the present invention;

FIG. 4 is a schematic view of defining a geometric error term in accordance with the present invention;

FIG. 5 is a schematic view of considering the definition of a geometric error term and thermal deformation in accordance with the present invention.

FIG. 6 is a schematic view of compensating a geometric error by an interpolation method in accordance with the present invention; and

FIG. 7 is a flow chart of a compensation method in accordance with the present invention;

### DETAILED DESCRIPTION OF THE PREFERRED EMBODIMENTS

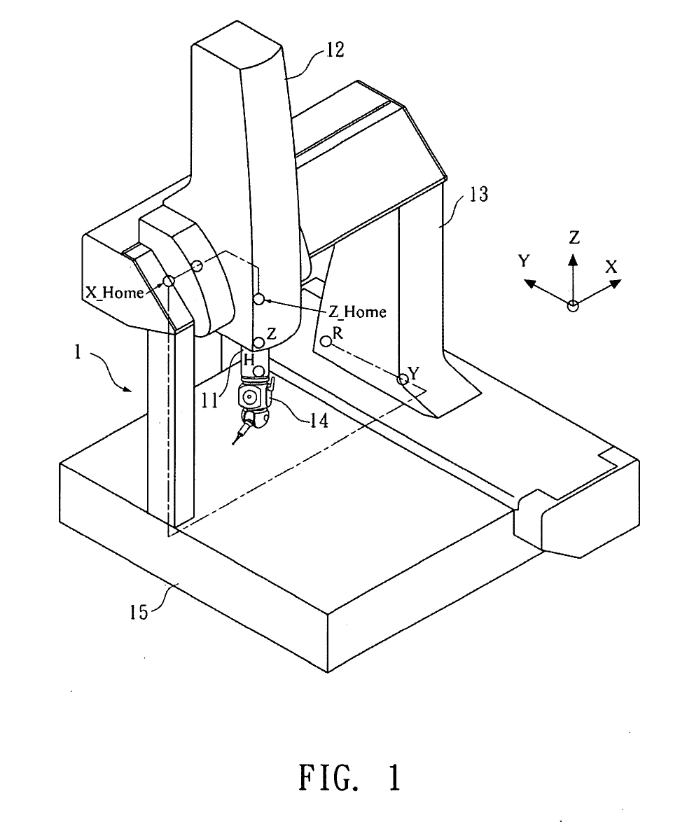

With reference to FIGS. 1 to 7, the present invention will now be described in more detail hereinafter with reference to the accompanying drawings that show various embodiments of the invention, and these embodiments are provided for illustrating the present invention, but not intended to limit the scope of the present invention.

This embodiment provides a thermal deformation error compensation method for a coordinate measuring machine. Firstly, a geometric error term of the coordinate measuring machine (CMM) is described as follows:

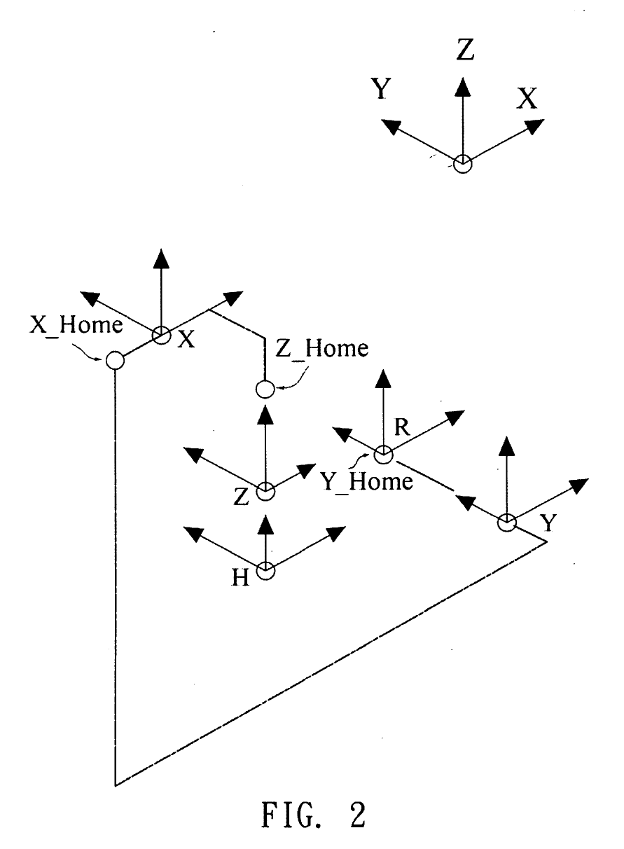

With reference to FIGS. 1 and 2 for a coordinate measuring machine 1 and its coordinate system in accordance with a preferred embodiment of the present invention, mechanical chains of the coordinate measuring machine 1 are interconnected and have three linear axes (X,Y,Z). The mechanical chain includes a Z-axis sliding table 11 moving along the Z-axis, and built on a X-axis sliding table 12, and the X-axis sliding table 12 is built on a Y-axis sliding table 13, and the three linear axes are perpendicular to each other. The mechanical chain includes a measuring probe 14 installed at the bottom of the Z-axis sliding table 12, and situated at a position opposite to the coordinate measuring machine 1 to serve as a datum point, and the Y-axis sliding table 13 is installed on a machine table 15 and combined with the machine table 15.

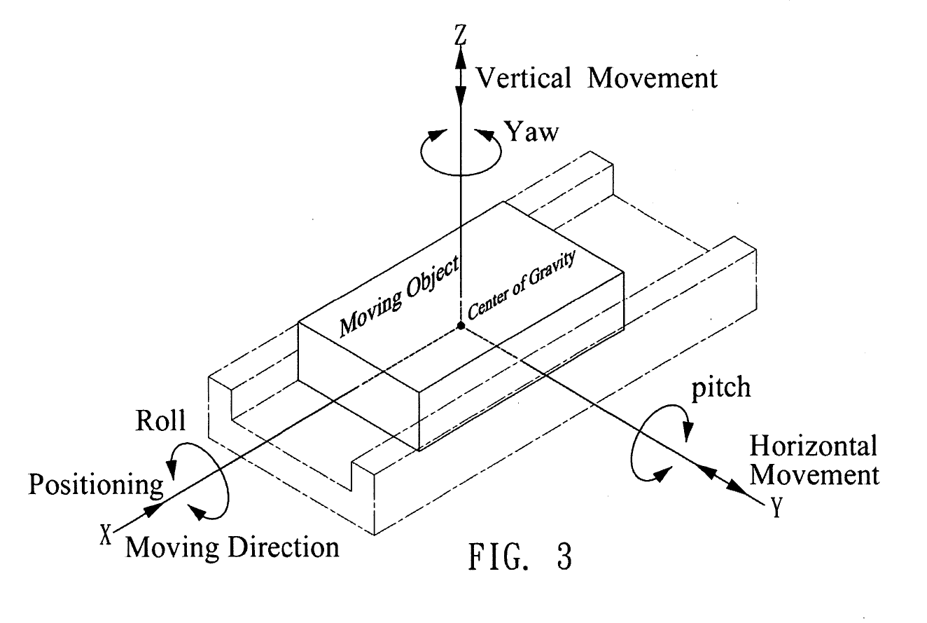

In FIG. 3, a single linear axis (X, Y or Z) of the coordinate measuring machine 1 has 6 geometric error terms which include three linear errors of positioning, horizontal and vertical errors and three angular errors of pitch, roll and yaw.

The aforementioned geometric error term varies with a moving position of the linear motion axis, and thus the coordinate measuring machine 1 has three linear axes and a total of 18 linear motion axis error terms. In addition, the three linear axes have three perpendicularity errors caused by the assembling, and the perpendicularity error terms can be simplified into constants. Therefore, the coordinate measuring machine 1 has a total of 21 geometric error terms.

In the aforementioned 21 geometric error terms, the roll angular error item of the linear motion axis is measured by a high-precision electronic leveler (not shown in the figure) in this embodiment, and the rest are measured by a laser interferometer (not shown in the figure).

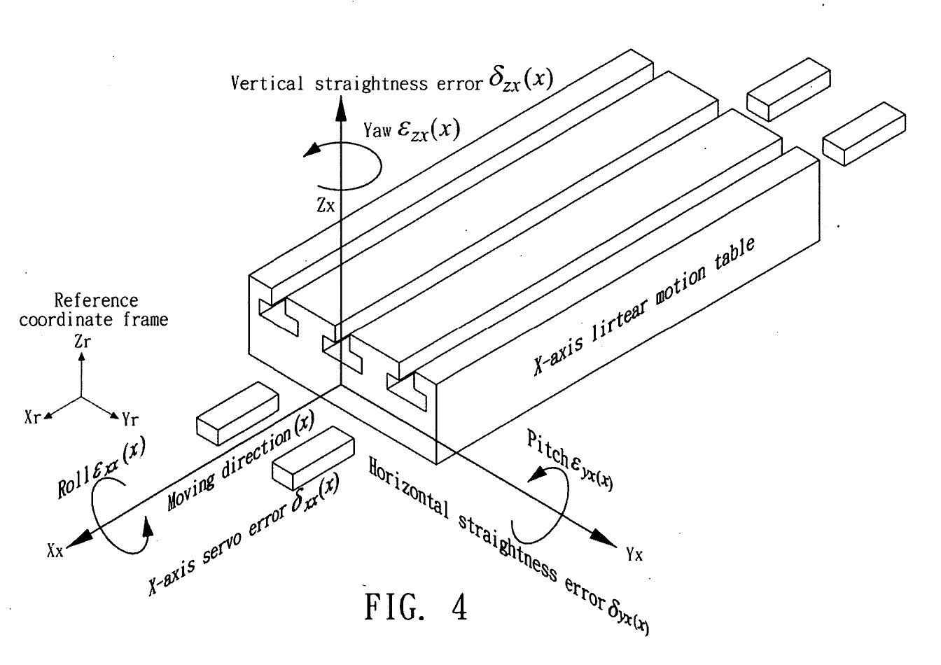

In a geometric error model of a coordinate measuring machine 1 at a specific temperature, 6 geometric error terms of a single linear motion axis can be expressed by a Homogeneous Transformation Matrix (HTM). For example, the 6 geometric error terms of a X-axis are defined as shown in FIG. 4 and the error Eₓ of the Homogeneous Transformation Matrix (HTM) including 6 error terms of the linear motion axis is given in the following equation:

$${E}_{x} = [ \begin{matrix}1 & - {ɛ}_{zx} ( x ) & {ɛ}_{yx} ( x ) & {δ}_{xx} ( x ) \\ {ɛ}_{zx} ( x ) & 1 & - {ɛ}_{xx} ( x ) & {δ}_{yx} ( x ) \\ - {ɛ}_{yx} ( x ) & {ɛ}_{xx} ( x ) & 1 & {δ}_{zx} ( x ) \\ 0 & 0 & 0 & 1\end{matrix} ] \qquad ( 1 )$$

Where ε_{zx}(x), ε_{yx}(x), εₓₓ(x), δₓₓ(x), δ_{yx}(x), δ_{zx}(x) are error items varied with a change of x in the moving position of the X-axis, and the error items are a function of x.

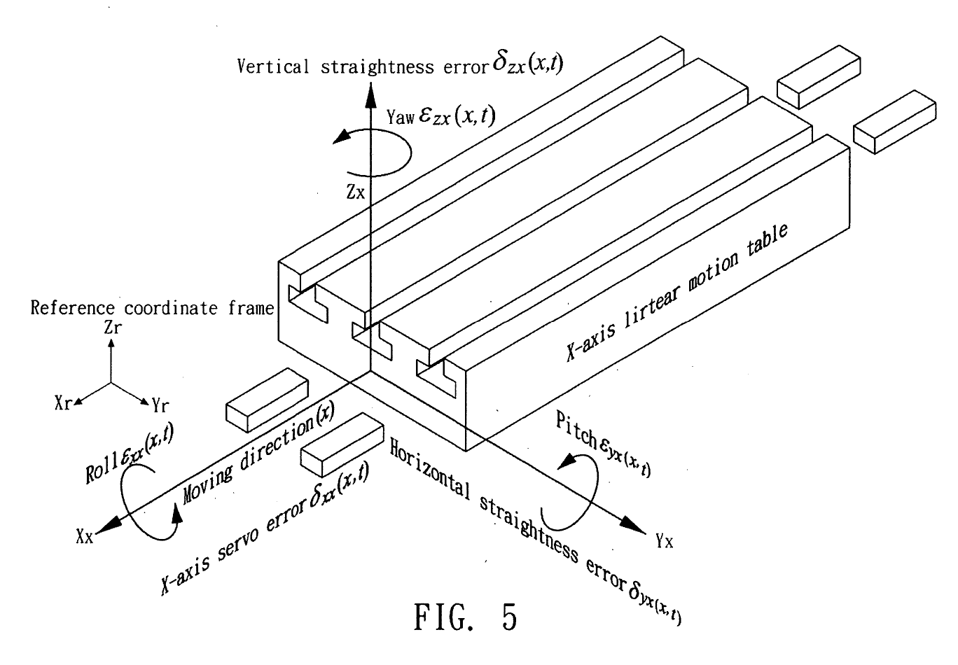

If geometric errors at different specific temperatures are taken into consideration as shown in FIG. 5, then Equation (1) will be modified to the following error model E_{x,t}:

$${E}_{x , t} = [ \begin{matrix}1 & - {ɛ}_{zx} ( x , t ) & {ɛ}_{yx} ( x , t ) & {δ}_{xx} ( x , t ) \\ {ɛ}_{zx} ( x , t ) & 1 & - {ɛ}_{xx} ( x , t ) & {δ}_{yx} ( x , t ) \\ - {ɛ}_{yx} ( x , t ) & {ɛ}_{xx} ( x , t ) & 1 & {δ}_{zx} ( x , t ) \\ 0 & 0 & 0 & 1\end{matrix} ] \qquad ( 2 )$$

Where, ε_{zx}(x,t), ε_{yx}(x,t), εₓₓ(x,t), δₓₓ(x,t), δ_{yx}(x,t), δ_{zx}(x, t) are error items varied with a change of x in the moving position of the X-axis and a change of temperature t, and the error items are a function of x and temperature t.

To effectively describe the total thermal deformation and geometric error of the coordinate measuring machine 1 caused by the thermal deformation and geometric error terms, we need to create a thermal deformation and geometric error model for the coordinate measuring machine 1.

The relation between each mechanical part of the machine and a servo (or manual) control axis can be represented by a 4×4 the Homogeneous Transformation Matrix (HTM), and the thermal deformation error model of the machine can be obtained by multiplying the Homogeneous Transformation Matrix (HTM) of each mechanical part and driving component according to the mechanical chain of the machine.

The reference coordinate system of the coordinate measuring machine 1 is defined at the position of a mechanical home position on the Y-axis, and the spatial relation ^{R}T_{H} between the holder coordinate system (H) and the reference coordinate system (R) is calculated as follows:

^{R}T_{H}=^{R}T_{Y} ^{Y}T_{X} ^{X}T_{Z} ^{Z}T_{H} (3)

where, ^{R}T_{Y} stands for the relation of the Y-axis coordinate system with respect to the reference coordinate system R; ^{Y}T_{X} stands for the relation of the X-axis coordinate system (X) with respect to the Y-axis coordinate system (Y); ^{X}T_{Z} stands for the relation of the Z-axis coordinate system (Z) with respect to the X-axis coordinate system (X); and ^{Z}T_{H} stands for the relation of the holder coordinate system (H) with respect to the Z-axis coordinate system (Z).

Therefore, the position errors P_{h,e}=└X_{h,e} Y_{h,e} Z_{h,e}┘ of the holder coordinate system (H) with respect to the reference coordinate system (R), including thermal deformation and geometric errors, can be calculated as follows:

[P_{h,e} 1]^{T}=^{r}Tₕ[0 0 0 1]^{T} (4)

For an ideal machine (free of thermal deformation and geometric error), the coordinates of the origin of the holder coordinate system (H) with respect to the reference coordinate system (R) can be obtained by deleting all error items in the foregoing matrix ^{r}T_{h,i}, and the position P_{h,i}=└X_{h,i} Y_{h,i} Z_{h,i}┘ is shown below:

[P_{h,i} 1]^{T}=^{r}T_{h,i}[0 0 0 1]^{T} (5)

Therefore, the error compensation vector P_{e,r} is

P_{e,r}=P_{h,e}−P_{h,i} (6)

Thus,

P_{e,r}=└ΔX_{e,r} ΔY_{e,r} ΔZ_{e,r}┘ (7)

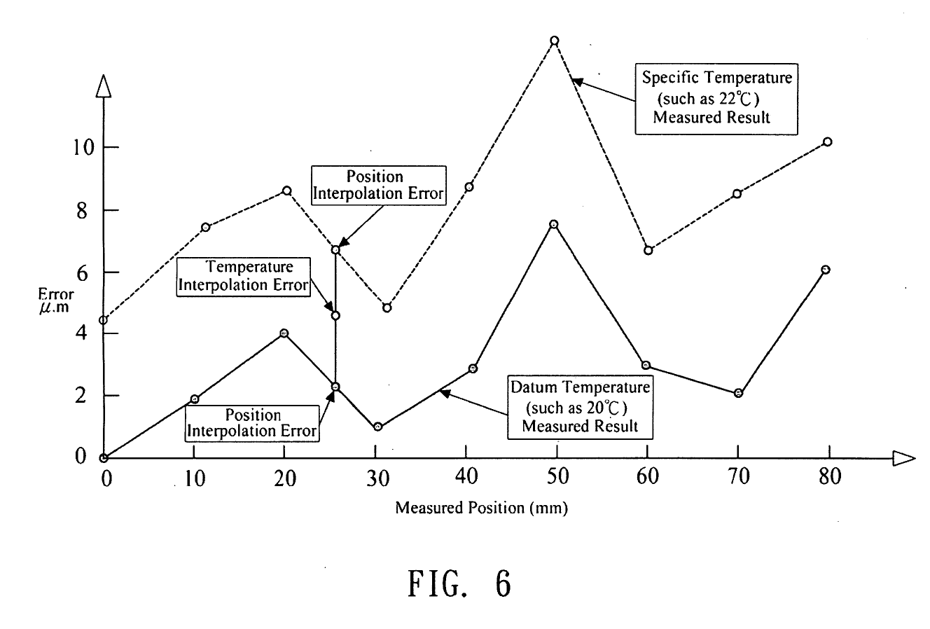

In the foregoing definitions of all geometric error terms at specific temperatures, such as ε_{zx}(x,t), ε_{yx}(x,t), . . . require a measuring tool for actually measuring and reflecting the actual situation of the machine, and the measuring method is to place the measuring coordinate measuring machine in a temperature-controlled laboratory, and carries out the steps of controlling the temperature of the temperature-controlled laboratory to a datum temperature (20° C.), measuring the geometric error terms of the linear motion axis by a high precision position measuring apparatus (such as a laser interferometer), setting the temperature-controlled laboratory sequentially to different specific temperatures for measuring geometric errors after the previous measurement completes, and finally creating a data chart of corresponding temperature and geometric error. In FIG. 6, the created data chart of corresponding temperature and geometric error has intervals of specific position and temperature, and thus the actual substituted geometric error can be interpolated, and then the temperature in interpolated to obtain the geometric errors of the linear motion axis movement to any different position and different operating temperature.

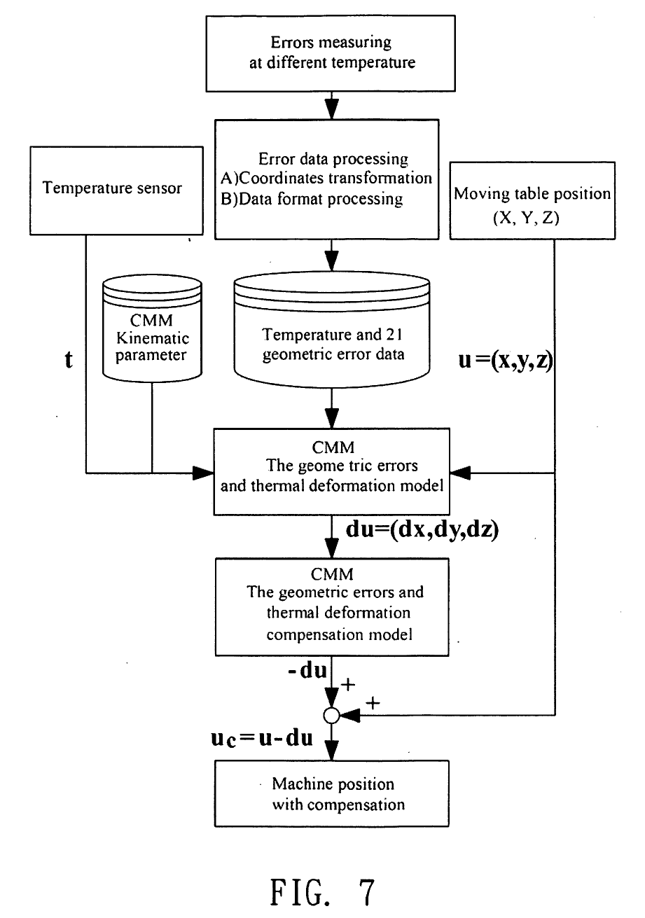

With reference to FIG. 7 for a thermal deformation error compensation method of a coordinate measuring machine 1 of the present invention, the method comprises the following steps:

1. Create the coordinate measuring machine thermal deformation and geometric error model: Use the Homogeneous Transformation Matrix (HTM) and follow a mechanical chain of the machine, and consider machine table positions and temperatures to create a thermal deformation and geometric error model of the three-axis machine having 21 geometric error tents.

2. Create the thermal deformation and geometric error data including measured data required for the thermal deformation and geometric error model, and the measuring method and procedure are described as follows: The environment of a temperature-controlled laboratory is controlled to a specific temperature, and a controller of the coordinate measuring machine 1 is used to drive the linear motion axis to be situated at a specific position, and a high precision measuring apparatus (such as a laser interferometer) is used for actually measuring the geometric error when the moving machine table is situated at a different position, and then the errors go through a coordinate transformation and a format processing to be converted into the same coordinate system and reading format of the thermal deformation and geometric error model. The temperature of the temperature-controlled laboratory is set to other specific temperatures. The aforementioned measurement is repeated for measuring the error data of the thermal deformation and geometric error terms of the coordinate measuring machine at different specific temperatures, and the error data are inputted to a central control unit of the coordinate measuring machine.

The thermal deformation and geometric error data and the kinematic parameters of the coordinate measuring machine 1, and these kinematic parameters, temperatures and thermal deformation and geometric error data are inputted to a central control unit (which is a major unit installed in the coordinate measuring machine 1 for operating and controlling the coordinate measuring machine 1, calculating parameters and accessing data, and not labeled in the figure) of the coordinate measuring machine 1.

3. Convert a 3D error. Since the thermal deformation and geometric error terms in a thermal deformation and geometric error model varies with different linear moving positions of the three axes and different operating temperatures of the coordinate measuring machine 1. Therefore, the position u (x, y, z) of an optical encoder scale and an operating temperature t of the machine in the thermal deformation and geometric error model must be known first. Data corresponding to the geometric errors measured at any temperature and any position of the environment are measured, and the thermal deformation and geometric errors at the position and operating temperature are estimated by an interpolation method. Finally, the thermal deformation and geometric error model is converted into a 3D error when the tool end is situated at any position of the machine working space.

4. Compensate the 3D error. If the measuring probe 14 is positioned at any position in a working space of the coordinate measuring machine 1, the thermal deformation and geometric error compensation model will be used for compensations to complete the thermal deformation and geometric error compensation.

Necessary the kinematic parameters of the coordinate measuring machine 1 must be inputted into the central control unit of the thermal deformation and geometric error model, and these kinematic parameters are obtained from the actual machine sizes. Now, the thermal deformation and geometric error model can be used to estimate the 3D error of a spatial error of a probe hoder end of the coordinate measuring machine 1 at different temperatures and when the three axes are moved to specific positions, and the 3D error is defined as du (dx, dy, dz), and the compensation of the thermal deformation and geometric errors is defined as −du, and the central control unit of the coordinate measuring machine 1 compensates the 3D error du (dx, dy, dz) with −du, and the coordinate measuring machine 1 is driven to an ideal position u_{c} to complete the thermal deformation and geometric error compensation.

In summation of the description above, the method of the invention is applied for the thermal deformation error compensation of a coordinate measuring machine 1, such that the coordinate measuring machine 1 can be driven to an ideal precise position at different temperatures, and the coordinate measuring machine 1 can be used at different ambient temperatures.

What is claimed is:

1. A thermal deformation error compensation method for a coordinate measuring machine, comprising:
creating thermal deformation and geometric error data: measuring a geometric error term of a linear motion axis by a high precision position measuring apparatus (such as a laser interferometer), actually measuring the coordinate measuring machine by a measuring tool to obtain multiple sets of geometric errors at different working temperatures, letting the result of the error measured by the measuring tool go through a coordinate transformation and a format processing to create different temperatures and their corresponding geometric errors, obtaining machine kinematic parameters which are geometric sizes of three axes X, Y, Z of a mechanical design architecture of the coordinate measuring machine, and data of the thermal deformation and geometric errors and the temperatures, and inputting the data into a central control unit of the coordinate measuring machine;
converting 3D error compensation: using an ambient temperature of the coordinate measuring machine measured by a temperature sensor to obtain data corresponding to the geometric errors measured at the ambient temperature, and using the thermal deformation and geometric error model to convert into a 3D error of the tool end positioned at any position of the machine motion space to obtain a thermal deformation and geometric error compensation; and
compensating the 3D error: performing a compensation for the thermal deformation and geometric error compensation model to complete a thermal deformation and geometric error compensation, if a measuring probe is situated at any position of the machine motion space.

2. The thermal deformation error compensation method for a coordinate measuring machine as recited in claim 1, wherein the thermal deformation and geometric error terms include three linear axes of the coordinate measuring machine, and each axis has three linear error terms including positioning, horizontal and vertical movements and three angular error terms including pitch, roll, and yaw movements, and the three linear axes has three perpendicularity errors caused by an assembling.

3. The thermal deformation error compensation method for a coordinate measuring machine as recited in claim 1, wherein the thermal deformation and geometric error model applies a Homogeneous Transformation Matrix (HTM), follows a mechanical chain of the machine, and considers a machine table position and a temperature function in the geometric error terms to create a thermal deformation and geometric error model of the three-axis machine including 21 geometric error terms.

4. The thermal deformation error compensation method for a coordinate measuring machine as recited in claim 1, wherein the thermal deformation and geometric error measured at the position and operating temperature is obtained by an interpolation method in order to obtain data corresponding to the corresponding geometric error measured at any temperature and any position of the environment, and finally the thermal deformation and geometric error model is converted into a 3D error of the tool end positioned at any position of the machine motion space.
